(19) United States
(12) Patent Application Publication
(10) Pub. No.: US 2023/0326378 A1
(43) Pub. Date: Oct. 12, 2023

(54) DECORATIVE PANEL AND DISPLAY PORTION

(71) Applicant: KABUSHIKI KAISHA TOKAI-RIKA-DENKI-SEISAKUSHO, Aichi (JP)

(72) Inventor: Hidetoshi HOSOKAWA, Aichi (JP)

(21) Appl. No.: 17/909,803

(22) PCT Filed: Jan. 27, 2021
(86) PCT No.: PCT/JP2021/002862

§ 371 Date: Sep. 7, 2022

(30) Foreign Application Priority Data
Mar. 23, 2020 (JP) 2020-051495

(51) Int. Cl. G09F 13/08; G09F 13/04

(52) U.S. Cl. CPC G09F 13/08; G09F 13/0413

(57) ABSTRACT

A decorative panel has a substrate including a light-transmissive material, and a light-blocking layer provided along one side surface of the substrate. The light-blocking layer is including a light-blocking material. Further, an opening through which light from the substrate side passes is formed in the light-blocking layer. A thickness dimension of the light-blocking layer in a direction facing the substrate is set to be less than or equal to 10 μm. Further, the decorative panel has a second coated layer that is provided on the light-blocking layer. The second coated layer is including a light-transmissive material, and covers the light-blocking layer in a state in which a portion of the second coated layer is disposed within the opening.

### TECHNICAL FIELD

The present invention relates to a decorative panel and a display portion.

### BACKGROUND ART

Japanese Patent Application Laid-Open (JP-A) No. 2000-57871 discloses a member for a push button switch. This member for a push button switch has an elastomer material that forms the substrate of the member for a push button switch, a light-transmissive colored layer that is layered on one side surface of the elastomer material, and a light-blocking colored layer that is layered on the one side surface of the elastomer material and on the light-transmissive colored layer. Further, part of the portion, which corresponds to the light-transmissive colored layer, of the light-blocking colored layer is a display portion that has been removed in the form of a symbol by laser etching. Due to such a structure, light from the elastomer material side passes through the light-transmissive colored layer, and is illuminated from the display portion.

By the way, it is thought that, in a structure in which a coated layer is further provided on the light-blocking colored layer, a step or a depression will form at the coated layer at the portion thereof corresponding to the display portion.

### SUMMARY OF INVENTION

### Technical Problem

In view of the above-described circumstances, an object of the present invention is to provide a decorative panel and a display portion that can suppress the formation of a step or a depression at the surface of a coated layer.

### Solution to Problem

A decorative panel relating to a first aspect comprises: a substrate comprising a light-transmissive material; a light-blocking layer comprising a light-blocking material, provided along one side surface of the substrate, having formed therein an opening through which light from the substrate side passes, and having a thickness dimension in a direction facing the substrate of less than or equal to 10 μm; and a coated layer comprising a light-transmissive material, provided on the light-blocking layer, and covering the light-blocking layer in a state in which a portion of the coated layer is disposed within the opening.

A decorative panel relating to a second aspect comprises: a substrate comprising a light-transmissive material; a light-blocking layer provided along one side surface of the substrate, having, at a substrate side thereof, a metal layer configured to include a light-blocking, metal material, having, at an opposite side from the substrate, a decorative layer, and having an opening through which light from the substrate side passes; and a coated layer comprising a light-transmissive material, provided on the light-blocking layer, and covering the light-blocking layer in a state in which a portion of the coated layer is disposed within the opening.

In a decorative panel relating to a third aspect, in the decorative panel relating to the second aspect, the metal layer is a deposited film that is made of a metal.

In a decorative panel relating to a fourth aspect, in the decorative panel of any of the first aspect through the third aspect, the light-blocking layer has a layer formed by printing, and the coated layer is a layer formed by printing or painting.

In a decorative panel relating to a fifth aspect, in the decorative panel of any of the first aspect through the fourth aspect, a character pattern portion that expresses at least one of a character or a pattern is formed at the light-blocking layer by a plurality of the openings, and, when a proportion of the character pattern portion that is occupied by the openings is an opening ratio, the opening ratio is in a range of 10 to 70%.

In a decorative panel relating to a sixth aspect, in the decorative panel of the fifth aspect, the character pattern portion is formed by a plurality of the openings which intersect in a form of a lattice.

A display portion relating to a seventh aspect comprises: a housing having one side that is open; a light source provided within the housing; and the decorative panel of any one of claim 1 through claim 6, which closes the open side of the housing in a state of being mounted at the housing.

### Advantageous Effects of Invention

In the decorative panel relating to the first aspect, the thickness dimension of the light-blocking layer in the direction facing the substrate is set to be less than or equal to 10 μm. Due thereto, the step that arises at the edge portion of the opening of the light-blocking layer can be suppressed. As a result, formation of a step or a depression at the portion, which corresponds to the opening of the light-blocking layer, of the surface of the coated layer can be suppressed.

In the decorative panel relating to the second aspect, by forming the metal layer by using a metal material having a strong light-blocking ability, the thickness of the metal layer can be made to be thin. Due thereto, an increase in the thickness of the light-blocking layer that has this metal layer can be suppressed, and the step that arises at the edge portion of the opening of the light-blocking layer can be suppressed. As a result, formation of a step or a depression at the portion, which corresponds to the opening of the light-blocking layer, of the surface of the coated layer can be suppressed.

In the decorative panel relating to the third aspect, by making the metal layer be a deposited film, the thickness of the metal layer can be made to be even thinner. Due thereto, an increase in the thickness of the light-blocking layer, which has the metal layer that is a deposited film, can be suppressed even more, and the step that arises at the edge portion of the opening of the light-blocking layer can be suppressed even more. As a result, formation of a step or a depression at the portion, which corresponds to the opening of the light-blocking layer, of the surface of the coated layer can be suppressed even more.

In the decorative panel relating to the fourth aspect, the light-blocking layer has a layer formed by printing. Due thereto, an increase in thickness of the light-blocking layer can be suppressed, as compared with a structure in which this layer formed by printing is a layer formed by painting. Further, even in a case of forming the coated layer by painting by which it is easy for steps or depressions corresponding to the shape and the like of the coated surface to arise, formation of a step or a depression at the portion, which corresponds to the opening of the light-blocking layer, of the surface of the coated layer can be suppressed.

In the decorative panel relating to the fifth aspect, the opening ratio, which is the proportion of the character pattern portion that is occupied by the openings, is set to be in a range of 10-70%. Due thereto, at the time of viewing the decorative panel relating to the fifth aspect from the side opposite the substrate in a state in which light from the substrate side does not pass through the openings of the light-blocking layer, the border between the character pattern portion and the portion other than the character pattern portion being seen can be prevented or suppressed.

In the decorative panel relating to the sixth aspect, the opening ratio can be easily adjusted by adjusting the interval between the plural openings that intersect in the form of a lattice.

In the display portion relating to the seventh aspect, when the light source within the housing is lit, the light from the light source passes through the substrate, the opening of the light-blocking layer, and the coated layer of the decorative panel, and is illuminated to the outer side of the housing. Here, by structuring the present display portion to include the decorative panel of any of the first aspect through the sixth aspect, formation of a step or depression at the surface of the coated layer can be suppressed.

### BRIEF DESCRIPTION OF DRAWINGS

FIG. 1 is a front view illustrating a display portion having a first decorative panel, and illustrates a state in which an LED is lit.

FIG. 2 is a cross-sectional view illustrating the display portion having the first decorative panel.

FIG. 3 is a cross-sectional view schematically illustrating the first decorative panel.

FIG. 4 is a cross-sectional view that corresponds to FIG. 3 and illustrates a decorative panel relating to a comparative example.

FIG. 5 is a cross-sectional view that corresponds to FIG. 3 and illustrates a second decorative panel.

FIG. 6 is a cross-sectional view that corresponds to FIG. 3 and illustrates a third decorative panel.

FIG. 7 is a front view that corresponds to FIG. 1 and illustrates the display portion having the third decorative panel.

FIG. 8 is a cross-sectional view that corresponds to FIG. 3 and illustrates a fourth decorative panel.

FIG. 9 is an enlarged front view in which a portion of a light-blocking layer, which is seen from the direction of arrow 9 illustrated in FIG. 8, is illustrated in an enlarged manner.

FIG. 10 is a front view that corresponds to FIG. 1 and illustrates the display portion having a fourth decorative panel, and illustrates a state in which an LED is lit.

FIG. 11 is a front view that corresponds to FIG. 1 and illustrates the display portion having the fourth decorative panel, and illustrates a state in which the LED is off.

FIG. 12 is an enlarged front view in which a portion of the light-blocking layer, which has a form different than that of FIG. 9, is illustrated in an enlarged manner.

FIG. 13 is a cross-sectional view that corresponds to FIG. 3 and illustrates a fifth decorative panel.

### DESCRIPTION OF EMBODIMENTS

### Structures of First Decorative Panel 10 and Display Portion 12

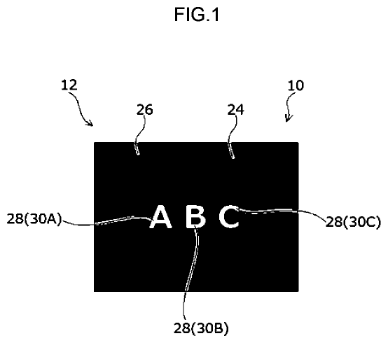

The structures of a first decorative panel 10 and a display portion 12 relating to embodiments of the present invention are described by using FIG. 1 through FIG. 3.

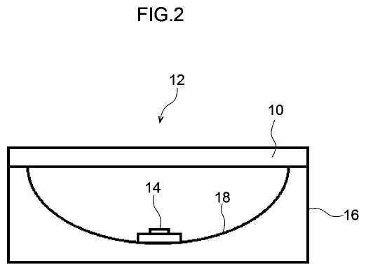

As illustrated in FIG. 1 and FIG. 2, the display portion 12 of the present embodiment displays characters on the decorative panel 10 due to an LED 14 that serves as a light source being lit. Note that, in the present embodiment, the characters “ABC” are displayed on the decorative panel 10. Note that a pattern may be displayed, or both characters and a pattern may be displayed, on the decorative panel 10.

The display portion 12 has a housing 16 whose one side is open and whose other side is closed, and the LED 14 that is provided at the closed side within the housing 16. Further, the display portion 12 has the decorative panel 10 that closes-off the open side at the housing 16 in a state of being mounted to the housing 16.

As illustrated in FIG. 2, the housing 16 is formed in the shape of a box by using, as an example, a resin material that is black and is light-blocking. A concave portion 18 that is concave is formed in the housing 16. The LED 14 is fixed to the bottom of the concave portion 18.

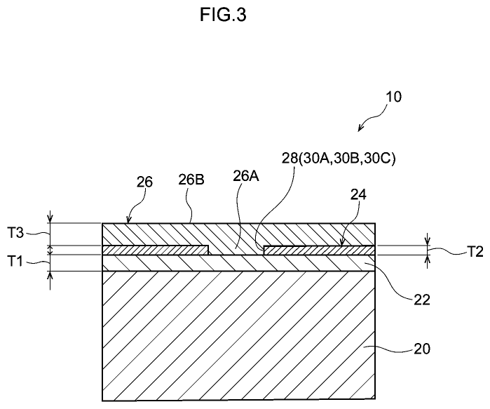

As illustrated in FIG. 3, the decorative panel 10 has, as an example, a substrate 20 that is formed in the shape of a plate by using a resin material that is colorless, transparent and light-transmissive, a first coated layer 22 layered on one side surface of the substrate 20, a light-blocking layer 24, and a second coated layer 26 serving as a coated layer.

As an example, the first coated layer 22 is formed in the shape of a thin sheet by using a resin material that is transparent, is colorless or colored, and is light-transmissive. Thickness T1 of the first coated layer 22 (the thickness in the direction facing the substrate 20) is several tens of μm. One side surface of the first coated layer 22 is joined to one side surface of the substrate 20. Further, the light-blocking layer 24 that is described layer is joined to the other side surface of the first coated layer 22. Note that, in other words, the first coated layer 22 can be said to function as a joining layer for joining the light-blocking layer 24 to one side surface of the substrate 20 in this structure. Note that there may be a structure in which the light-blocking layer 24 is directly joined to one side surface of the substrate 20 without providing the first coated layer 22.

The light-blocking layer 24 is formed by transferring black ink onto the first coated layer 22 by gravure printing or the like. Thickness T2 of the light-blocking layer 24 (the thickness in the direction facing the substrate 20) is set to be 3-5 μm. Further, openings 28 of predetermined shapes are formed in the light-blocking layer 24 by carrying out a process such as laser cutting or the like. The shapes of the openings 28 correspond to the characters “ABC” illustrated in FIG. 1. Note that the portion of the light-blocking layer 24 corresponding to the character “A” is called character pattern portion 30A. This character pattern portion 30A is formed by a single opening 28A. Further, the portion of the light-blocking layer 24 corresponding to the character “B” is called character pattern portion 30B. This character pattern portion 30B is formed by a single opening 28B. Moreover, the portion of the light-blocking layer 24 corresponding to the character “C” is called character pattern portion 30C. This character pattern portion 30C is formed by a single opening 28C.

The second coated layer 26 is formed by carrying out painting by a paint on the light-blocking layer 24 and on the portions, which correspond to the openings 28 of the light-blocking layer 24, of the first coated layer 22. In the present embodiment, the second coated layer 26 is formed by using a colorless, transparent paint. Further, thickness T3 of the second coated layer 26 on the light-blocking layer 24 (the thickness in the direction facing the substrate 20) is around 20 μm. Moreover, portions 26A of the second coated layer 26 are in states of being within the openings 28 of the light-blocking layer 24 without any gaps.

### Operation and Effects of Present Embodiment

Operation and effects of the present embodiment are described next.

As illustrated in FIG. 1 and FIG. 2, at the display portion 12 of the present embodiment, when the LED 14 within the housing 16 is lit, light from the LED 14 passes through the substrate 20, the first coated layer 22, the openings 28 of the light-blocking layer 24, and the second coated layer 26 of the decorative panel 10, and is illuminated to the outer side. Due thereto, the portions, which correspond to the character pattern portions 30A, 30B, 30C, of the decorative panel 10 are in shining states, and the characters “ABC” are displayed on the decorative panel 10.

Further, in the state in which the LED 14 within the housing 16 is off, there is a state in which light from within the housing 16 is not illuminated from the openings 28 of the light-blocking layer 24 at the decorative panel 10. As a result, the portions corresponding to the character pattern portions 30A, 30B, 30C at the decorative panel 10 are in black states, and the entirety of the decorative panel 10 is in a black state (blacked-out state).

Here, at the display portion 12 of the present embodiment, the thickness T2 (thickness dimension) of the light-blocking layer 24 that structures a portion of the decorative panel 10 is set to be 3-5 μm. Due thereto, steps that arise at the edge portions of the openings 28 of the light-blocking layer 24 (the height difference corresponding to the thickness T2 of the light-blocking layer 24) can be suppressed. As a result, the volume of paint (the paint that forms the second coated layer 26) that enters into the interiors of the openings 28 of the light-blocking layer 24 can be reduced, and sink marks forming at the portions, which correspond to the openings 28 of the light-blocking layer 24, of the second coated layer 26 can be suppressed. Further, steps and depressions arising at the portions, which correspond to the openings 28 of the light-blocking layer 24, of surface 26B of the second coated layer 26 can be suppressed. Here, it has been learned from trial production and the like that, if the thickness T2 (thickness dimension) of the light-blocking layer 24 is set to be less than or equal to 10 μm, steps and depressions that can be seen visually do not arise at the portions, which correspond to the openings 28 of the light-blocking layer 24, of the surface 26B of the second coated layer 26.

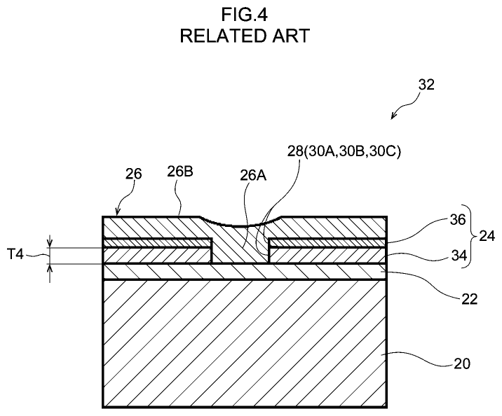

Note that, in the structure of a decorative panel 32 that relates to a comparative example illustrated in FIG. 4, the light-blocking layer 24 is a two-layer structure formed by a middle coat 34 that is formed by carrying out painting by a paint, and a transfer layer 36 that is layered on this middle coat 34. Note that, at the decorative panel 32 relating to the comparative example, members and portions corresponding to the above-described decorative panel 10 (see FIG. 3) are denoted by the same reference numerals as the corresponding members and portions of the decorative panel 10. Further, at the decorative panel 32 relating to the comparative example, the steps, which arise at the edge portions of the openings 28 of the light-blocking layer 24 due to thickness T4 of the middle coat 34 that is a coated film being around 20 μm, are larger than those of the above-described decorative panel 10. As a result, it is difficult to suppress the formation of steps and depressions at the portions, which correspond to the openings 28 of the light-blocking layer 24, of the surface 26B of the second coated layer 26.

As described above, in the present embodiment, the light-blocking layer 24 is formed of ink. Due thereto, the thickness of the light-blocking layer 24 increasing can be suppressed, as compared with a structure in which the light-blocking layer 24 is a layer formed of paint (the structure of the decorative panel 32 relating to the comparative example). Further, even in a case of forming the second coated layer 26 by paint at which it is easy for steps and depressions corresponding to the shape and the like of the coated surface to arise, steps and depressions forming at the portions, which correspond to the openings 28 of the light-blocking layer 24, of the surface of the second coated layer 26 can be suppressed.

### Structure of Second Decorative Panel 38

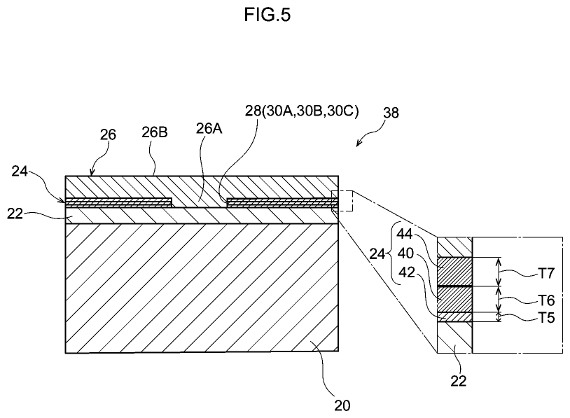

Next, the structure of a second decorative panel 38 relating to an embodiment of the present invention is described by using FIG. 5. Note that, at the second decorative panel 38, members and portions corresponding to the above-described decorative panel 10 (see FIG. 3) are denoted by the same reference numerals as the corresponding members and portions of the decorative panel 10, and there are cases in which description thereof is omitted.

As illustrated in FIG. 5, at the second decorative panel 38, the light-blocking layer 24 is structured to include a deposited layer 40 that serves as a metal layer formed by a deposited film. Specifically, the light-blocking layer 24 has a first gravure printed layer 42 formed by black ink being gravure printed on the first coated layer 22, the deposited layer 40 that is formed by aluminum being deposited on the first gravure printed layer 42, and a second gravure printed layer 44 that is formed by black ink being gravure printed on the deposited layer 40. The light-blocking layer 24 is formed by being transferred onto the first coated layer 22. Although the first gravure printed layer 42 is a layer that is light-blocking, the light-blocking ability thereof is weak, and, in the present embodiment, the first gravure printed layer 42 functions as an adhesive layer for joining the deposited layer 40 to one side surface of the first coated layer 22. Thickness T5 of this first gravure printed layer 42 is set to be less than or equal to 1 μm. Further, the deposited layer 40 is a layer whose light transmittance rate is less than or equal to 10%, and is set to a thickness T6 of several μm as an example. Although the second gravure printed layer 44 is a layer that is light-blocking, in the present embodiment, the second gravure printed layer 44 functions as a decorative layer for making the design of the second decorative panel 38 be a predetermined design (pattern). Thickness T7 of this second gravure printed layer 44 is set to be less than or equal to 3-5 μm. Further, the thickness of the light-blocking layer 24, which combines these thicknesses T5, T6 and T7, is less than or equal to 10 μm.

In the structure of the above-described second decorative panel 38 as well, in the same way as the above-described decorative panel 10 (see FIG. 3), steps and depressions forming at the portions, which correspond to the openings 28 of the light-blocking layer 24, of the surface 26B of the second coated layer 26 can be suppressed. Further, at the second decorative panel 38, by structuring the light-blocking layer 24 to include the deposited layer 40 that is formed by a deposited film, the light-blocking ability of the light-blocking layer 24 is ensured, and moreover, the design of the decorative panel 38 can be made to be a desired design. Note that a layer, which is formed by an ink containing a metallic pigment, may be formed instead of the deposited layer 40. Further, due to the light-blocking layer 24 being structured to include the deposited layer 40 that is formed by a deposited film, the light-blocking ability of the light-blocking layer 24 can be ensured without forming the light-blocking layer 24 to be thick and regardless of the pattern of the second gravure printed layer 44 (even if the light-blocking ability of the second gravure printed layer 44 is weak).

### Structure of Third Decorative Panel 46

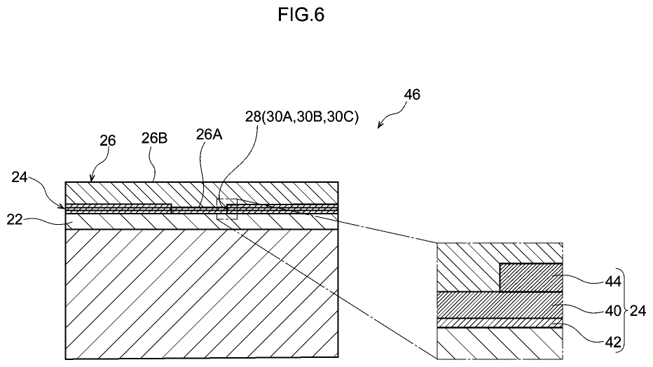

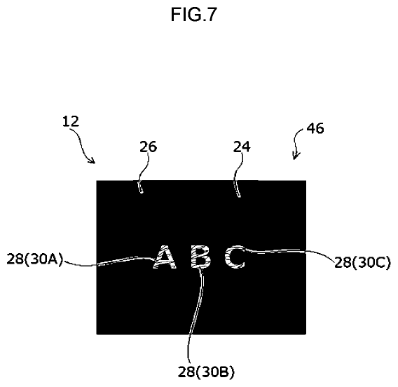

Next, the structure of a third decorative panel 46 relating to an embodiment of the present invention is described by using FIG. 6 and FIG. 7. Note that, at the third decorative panel 46, members and portions corresponding to the above-described second decorative panel 38 (see FIG. 5) are denoted by the same reference numerals as the corresponding members and portions of the decorative panel 38, and there are cases in which description thereof is omitted.

As illustrated in FIG. 6 and FIG. 7, at the third decorative panel 46, the openings 28 are formed by only portions of the second gravure printed layer 44 of the light-blocking layer 24 being removed by a processing such as laser cutting or the like. Due thereto, portions of the deposited layer 40 can be seen through the openings 28 as the character pattern portions 30A, 30B, 30C. At this third decorative panel 46, when the LED 14 (see FIG. 2) within the housing 16 is lit, some of the light passes through the thin deposited layer 40. Due thereto, the portions, which correspond to the character pattern portions 30A, 30B, 30C, of the decorative panel 46 enter into states of shining faintly (states of shining more faintly than at the first decorative panel 10 and the second decorative panel 38), and the characters “ABC” are faintly displayed on the decorative panel 46.

Further, in the state in which the LED 14 within the housing 16 is off, the metal gloss (the metal gloss effect) of the deposited layer 40 can be obtained at the portions, which correspond to the character pattern portions 30A, 30B, 30C, of the decorative panel 46. Due thereto, in the present embodiment, the design formed by the metal gloss effect can be expressed at the portions corresponding to the character pattern portions 30A, 30B, 30C.

### Structure of Fourth Decorative Panel 48

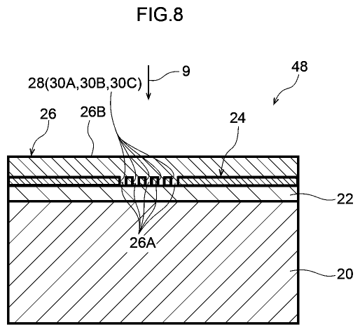

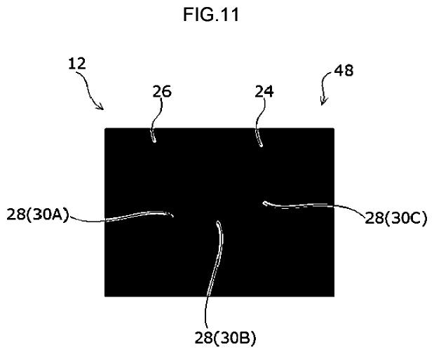

Next, the structure of a fourth decorative panel 48 relating to an embodiment of the present invention is described by using FIG. 8˜FIG. 11. Note that, at the fourth decorative panel 48, members and portions corresponding to the above-described decorative panel 10 (see FIG. 3) are denoted by the same reference numerals as the corresponding members and portions of the decorative panel 10, and there are cases in which description thereof is omitted.

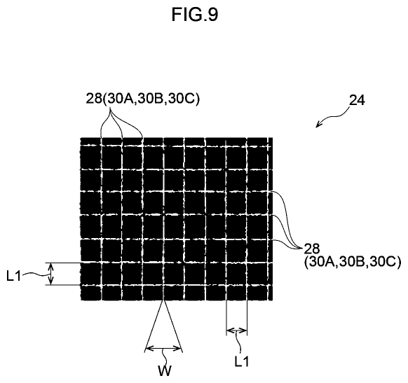

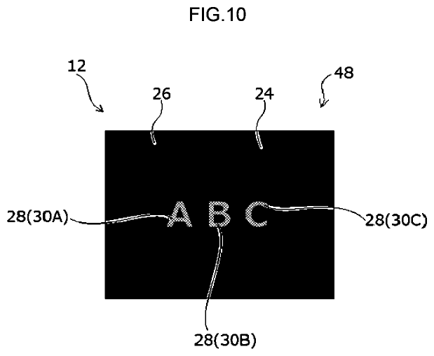

As illustrated in FIG. 8 and FIG. 9, at the fourth decorative panel 48, the character pattern portions 30A, 30B, 30C are formed by the plural openings 28 that are linear and continuous and intersect in the form of a lattice. Here, the proportion that is occupied by the openings 28 at the character pattern portions 30A, 30B, 30C is called the opening ratio. Width W of each of the openings 28 and interval L1 between the openings 28 are set such that the opening ratio is in the range of 10-70%. Here, in the present embodiment, the width W of the opening 28 is set in the range of 15-35 μm, and the interval L1 between the openings 28 is set to an interval that is 1.1-20 times the width W. By setting the opening ratio to these ranges, it can be made such that the character pattern portions 30A, 30B, 30C can be seen when the LED 14 (see FIG. 2) is lit as illustrated in FIG. 10, and the character pattern portions 30A, 30B, 30C cannot be seen when the LED 14 is off as illustrated in FIG. 11. Note that, in order to make it impossible to see the character pattern portions 30A, 30B, 30C at the time when the LED 14 is off, it is effective to make the light-blocking layer 24 be a black color of a uniform density. Further, by setting the opening ratio to be greater than or equal to 10%, the character pattern portions 30A, 30B, 30C can be seen when the LED 14 (see FIG. 2) is lit as illustrated in FIG. 10, and, by setting the opening ratio to be less than or equal to 70%, when the LED 14 is off as illustrated in FIG. 11, the character pattern portions 30A, 30B, 30C also can be made to be similar to the pattern of the light-blocking layer 24, and therefore, the decorative panel 48 can be made to be a uniform pattern when the LED 14 is off. Note that, at the above-described decorative panel 10 (see FIG. 3) and the decorative panel 48 of the present embodiment, although the sizes of the openings 28 are different, the thickness of the light-blocking layer 24 is less than or equal to 10 μm at both. Due thereto, the formation of steps and depressions can be suppressed at both, regardless of the difference in the sizes of the openings 28, and regardless of the paint that forms the second coated layer 26.

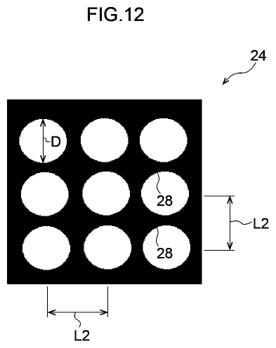

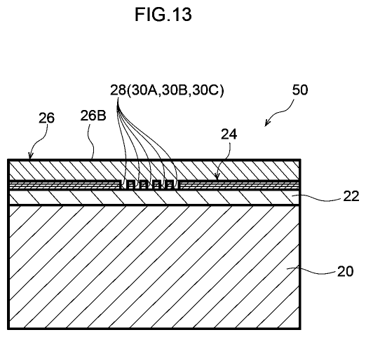

Further, as illustrated in FIG. 12, the opening ratio may be adjusted by adjusting inner diameter D of the plural openings 28 that are circular, and interval L2 between the openings 28. Note that it has been learned from trial production and the like that, by setting the inner diameter D of the plural, circular openings 28 to be less than 0.09 mm, and setting the interval L2 between the openings 28 to be less than 0.09 mm, the dot-shaped pattern formed by the plural, circular openings 28 cannot be seen. Further, as illustrated in FIG. 13, there may be a decorative panel 50 at which the structures illustrated in FIG. 8˜FIG. 12 are applied to the light-blocking layer 24 that is structured to include the deposited layer 40 formed by a deposited film at the decorative panels 28, 46.

Although embodiments of the present invention have been described above, the present invention is not limited to the above and can, of course, be implemented by being modified in various ways other than the above within a scope that does not depart from the gist thereof.

The disclosure of Japanese Patent Application No. 2020-051495 filed on Mar. 23, 2020 is, in its entirety, incorporated by reference into the present specification.

1. A decorative panel, comprising:
a substrate comprising a first light-transmissive material;
a light-blocking layer comprising a light-blocking material, provided along one side surface of the substrate, having formed therein an opening through which light from the substrate side passes, and having a thickness dimension in a direction facing the substrate of less than or equal to 10 μm; and
a coated layer comprising a second light-transmissive material, provided on the light-blocking layer, and covering the light-blocking layer in a state in which a portion of the coated layer is disposed within the opening.

2. A decorative panel, comprising:
a substrate comprising a first light-transmissive material;
a light-blocking layer provided along one side surface of the substrate, having, at a substrate side thereof, a metal layer configured to include a light-blocking, metal material, having, at an opposite side from the substrate, a decorative layer, and having an opening through which light from the substrate side passes; and
a coated layer comprising a second light-transmissive material, provided on the light-blocking layer, and covering the light-blocking layer in a state in which a portion of the coated layer is disposed within the opening.

3. The decorative panel of claim 2, wherein the metal layer is a deposited film that is made of a metal.

4. The decorative panel of claim 1, wherein:
the light-blocking layer has a layer formed by printing, and the coated layer is a layer formed by printing or painting.

5. The decorative panel of claim 1, wherein:
a character pattern portion that expresses at least one of a character or a pattern is formed at the light-blocking layer by a plurality of the openings, and when a proportion of the character pattern portion that is occupied by the openings is an opening ratio, the opening ratio is in a range of 10 to 70%.

6. The decorative panel of claim 5, wherein the character pattern portion is formed by a plurality of the openings, which intersect in a form of a lattice.

7. A display portion, comprising:
a housing having one side that is open;
a light source provided within the housing; and
the decorative panel of claim 1, which closes the open side of the housing in a state of being mounted at the housing.
